(19) United States
(12) Patent Application Publication
(10) Pub. No.: US 2014/0274259 A1
(43) Pub. Date: Sep. 18, 2014

(54) BONUS ALLOCATION AND PROVISIONING SYSTEM AND METHOD FOR WAGERING GAMES

(71) Applicants: Steven Terrance Gold, Las Vegas, NV (US); Jeremy Wood Zarowitz, Katy, TX (US)

(72) Inventors: Steven Terrance Gold, Las Vegas, NV (US); Jeremy Wood Zarowitz, Katy, TX (US)

(21) Appl. No.: 14/214,340

(22) Filed: Mar. 14, 2014

Related U.S. Application Data
(60) Provisional application No. 61/783,740, filed on Mar. 14, 2013.

(51) Int. Cl. G07F 17/32

(52) U.S. Cl. CPC G07F 17/3244; G07F 17/3293
USPC 463/13; 463/25

(57) ABSTRACT

A bonusing system allocates bonus awards randomly within a plurality of sets of indicia by inserting a bonus triggering indicia within a subset of the plurality of sets of indicia. Each set of indicia is randomized or shuffled for use in a base game. One of the sets of indicia is randomly selected for use in the base game. During play of the base game, a player is automatically paid a bonus award upon receiving the bonus triggering indicia. If the player achieves a winning outcome at the base game, the player is also paid an award associated with such winning outcome. The bonusing system is configured for use with a variety of wagering games, including video poker, keno and blackjack among others.

### CROSS-REFERENCE TO RELATED APPLICATION.

This application claims priority to U.S. Provisional Patent Application No. 61/783,740, filed Mar. 14, 2013.

### BACKGROUND OF THE INVENTION

1. Field of the Invention

The invention relates to bonus games and awards for wagering games, and particularly to a bonus distribution and provisioning system and method for wagering games and gaming machines.

2. Related Art

Various jackpot or bonus games have been developed for wagering games to add to player enticement and excitement while playing a wagering game. This increases play at wagering games while also providing bonus awards to players that achieve an outcome that entitles them for the bonus.

Typically, a bonus must be achieved by achieving a winning outcome in a base game, or by playing a bonus game to a winning outcome or that entitles a player to the bonus award. Thus, the bonus award is tied to player achievement. In addition, a player must typically qualify for a bonus award, such as by placing an additional wager or by placing a wager of sufficient size in a base game associated with the bonus award. This is in large part to ensure adequate funding for the bonus award by player wagers.

From the discussion that follows, it will become apparent that the present invention addresses the deficiencies associated with the prior art while providing numerous additional advantages and benefits not contemplated or possible with prior art constructions.

### SUMMARY OF THE INVENTION

A bonus allocation and provisioning system (hereinafter “bonusing system”) is configured to randomly allocate bonus awards within a random subset of individual sets of indicia for payout to players of a base game. The bonusing system and methods thereof may be configured and implemented in various ways, as will be disclosed in further detail below.

The bonusing system and methods thereof may be implemented in various ways. For example, the a gaming system providing a bonus award is disclosed, comprising one or more memory devices for storing one or more individual sets of indicia and a plurality of winning outcomes, one or more random number generators, and one or more controllers.

The controllers may be configured to allocate payout of bonus awards to the individual sets of indicia by selectively associating one or more bonus triggering indicia with the individual sets of indicia. Output of the random number generators determines whether any of the bonus triggering indicia are associated with the individual sets of indicia.

The controllers also are configured to randomize the indicia in the individual sets of indicia and receive a wager from a player, identify a selected one of the individual sets of indicia, and present a plurality of the indicia from the selected individual set of indicia to the player. The player is awarded a first award if the plurality of indicia include at least one of the bonus triggering indicia and awarded an additional second award if the plurality of indicia match at least one of the plurality of winning outcomes. The first award is presented to the player via a display if awarded.

The bonus triggering indicia may be associated with the individual sets of indicia by adding the bonus triggering indicia at a random location within the individual sets of indicia. Alternatively or in addition, the bonus triggering indicia may be associated with the individual sets of indicia by combining the bonus triggering indicia with a randomly selected indicia within the individual sets of indicia.

It is noted that the controller may be configured to replace one or more of the plurality of indicia with additional indicia from the selected individual set of indicia before the additional second award can be or is awarded to the player. Various indicia and winning outcomes may be defined. For example, the indicia in the plurality of individual sets of indicia may be playing cards, and each of the plurality of winning outcomes may be a predefined poker hand. Each of the individual sets of indicia consists of the same indicia.

In another exemplary embodiment, a gaming device is disclosed, comprising one or more memory devices configured to store one or more individual sets of indicia with the indicia within each of the individual sets of indicia being in a random order, and a controller configured to allocate payout of bonus awards.

The controller allocates payout of bonus awards by randomly determining whether to associate one or more bonus triggering indicia with at least one of the individual sets of indicia, associating one or more bonus triggering indicia with at least one of the individual sets of indicia based on the random determination, and identifying a selected one of the individual sets of indicia. A display is provided to present a plurality of indicia from the selected individual set of indicia to a player;

The player is awarded a first award only if the plurality of indicia include at least one of the bonus triggering indicia, and the player is awarded an additional second award only if the plurality of indicia form a predefined winning outcome.

Similar to above, the bonus triggering indicia may be associated in various ways. For example, the bonus triggering indicia may be associated with the individual sets of indicia by adding the bonus triggering indicia at a random location within the individual sets of indicia, or by combining the bonus triggering indicia with a randomly selected indicia within the individual sets of indicia.

The controller may be configured to replace one or more of the plurality of indicia with additional indicia from the selected individual set of indicia before the additional second award can be or is awarded to the player. The indicia in the plurality of individual sets of indicia may be playing cards. In addition, the predefined winning outcome may be a predefined poker hand. Each of the individual sets of indicia may consists of the same indicia. A wager acceptor may be included as well. In such case, a wager received via the wager acceptor can then be required before the plurality of indicia are presented on the display.

Various methods are also disclosed herein. For example, in one embodiment a method for allocating bonus awards with a gaming system is disclosed, comprising storing one or more individual sets of indicia on one or more memory devices, allocating payout of bonus awards by randomly associating one or more bonus triggering indicia with the individual sets of indicia based on output of one or more random number generators, and randomly selecting one of the plurality of sets of indicia for use in play of a base game. It is noted that the indicia within each of the individual sets of indicia are in a random order.

The method also includes receiving a wager from a player via an input device, providing one or more game rounds during the base game during which a plurality of indicia from the randomly selected set of indicia are presented to the player via a display, awarding the player a first award if the plurality of indicia includes at least one of the bonus triggering indicia, and awarding the player a second additional award if the plurality of indicia forms a predefined winning outcome.

The bonus triggering indicia may be associated with the individual sets of indicia by adding the bonus triggering indicia at a random location within the individual sets of indicia. Alternatively or in addition, the bonus triggering indicia may be associated with the individual sets of indicia by combining the bonus triggering indicia with a randomly selected indicia within the individual sets of indicia.

The plurality of sets of indicia may be playing cards. Also, each of the individual sets of indicia may consist of the same indicia.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 illustrates an exemplary gaming machine for use with the bonusing system;

FIG. 2 illustrates components of an exemplary gaming machine and bonusing system;

FIG. 3 is a flow diagram illustrating operation of an exemplary bonusing system;

FIG. 4 is a flow diagram illustrating operation of an exemplary bonusing system;

FIG. 5A is a block diagram illustrating an exemplary bonus triggering indicia; and

FIG. 5B is a block diagram illustrating an exemplary bonus triggering indicia.

### DETAILED DESCRIPTION OF THE PREFERRED EMBODIMENTS

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

In general, the bonusing system herein allocates bonus awards randomly within a plurality of sets of indicia by inserting a bonus triggering indicia within a random subset of the plurality of sets of indicia. One of the sets of indicia (from the overall plurality of sets of indicia) is then selected for use during play of a base game. In this manner, the bonusing system can subsequently provide a bonus award to a player automatically upon the player's receipt of the bonus triggering indicia during play of the base game. As will be detailed further below, the bonusing system's bonus award allocation process randomly allocates the predefined bonus triggering indicia such that large life-changing bonus awards can be funded and paid to players.

FIG. 1 illustrates an exemplary gaming machine 104 at which the bonusing system may be provided. In one embodiment, the gaming machine 104 configured to present one or more wagering games to a player that offer the possibility of an award of winnings The winnings may be various items of value, including coins and other currency, tokens, points, tickets, prizes or the like.

The gaming machine 104 may be configured to present various types or configurations of base games having the inventive features of the bonusing system described herein. These may include video poker games, slot-type games, keno, and blackjack or other card, dice or various other wagering games now known or later developed. Typically, certain game outcomes will be designated as winning outcomes. As described above, awards may be provided for these winning outcomes, such as monetary payments (or representations thereof, such as award of credits), prizes or the like. The number of winning outcomes may vary dependent upon the desired payout or winning percentage offered to the players as compared to wagers that are retained by the gaming establishment.

The gaming machine 104 preferably includes at least one display device 108 configured to display game information. The display device 108 may be a mechanical, electro-mechanical or electronic display, a video display or the like. When the display device 108 is an electronic video display, it may comprise a cathode ray tube (CRT), high resolution flat panel liquid crystal display (LCD), projection LCD, plasma display, field emission display, digital micro-mirror display (DMD), digital light processing display (DLP), LCD touch screen, a light emitting display (LED), organic light emitting display (OLED), eInk, or other suitable displays now known or later developed, in a variety of resolutions, sizes and formats.

The display device 108 may be capable of presenting or displaying a wide variety of information, including images, paytables, symbols and other indicia or information associated with play of a wagering game at the gaming machine 104. With regard to the bonusing system, the display device 108 may present a notification or alert when a player wins the bonus award provided by the bonusing system. In addition, the display device 108 may present the predefined bonus triggering indicia that results in the payout of the bonus award as part of presenting a base wagering game at a gaming machine 104.

The gaming machine 104 may include one or more input devices 112 (such as input buttons, pull handle, a touch-screen display, joystick, touch-pad or the like) that may receive input from a player to facilitate game play. As shown for example, the gaming machine 104 of FIG. 1 includes input devices 112 in the form of buttons. In one or more embodiments, the input devices may be used to permit a player to play or interact with a game. An input device 112 may also be used to initiate play or start a game such as by causing a wager to be placed or one or more indicia to be dealt or presented to a player. It is contemplated that the input devices 112 may also or alternatively be various other controls, such as sliders, switches, scroll bars, and the like implemented by physical devices or as on touch-enable screen elements presented on the display 108.

The gaming machine 104 may also include one or more peripherals, such as a wager acceptor 116 such as a coin or bill acceptor for accepting coins or paper money and/or a currency or a card reader for reading player tracking cards, credit cards, ATM cards, or the like for the purpose of receiving a wager. Some other exemplary peripherals include speakers, voucher/payout ticket printers, voucher/payout ticket scanners, coin or currency dispensers, and the like.

The gaming machine 104 will typically also include a means for paying a player any winnings accumulated during game play. In one or more embodiments for example, an input device 112 may be configured to initiate a payout of the winnings, credits or other awards the player has earned.

A payout dispenser 120 is typically provided to provide the payout desired by the player. For example, the payout dispenser 120 may be a coin dispenser or other payout-handling device, which delivers the proper number of coins to the player. The payout dispenser may also or alternatively be configured to dispense a ticket or other media, such as via a printer, or electronically such as by transferring credits or currency to the player's bank account or player tracking account.

The gaming machine 104 may be configured as a stand-alone device or be a component in a gaming system in communication with one or more external devices, such as through one or more communication devices. For example, the gaming machine 104 may be configured as a client-type device and obtain game code, game outcomes or both from a remote server 124 through network or other communications. A remote server 124 may be configured to perform accounting, player tracking, game generation, random number generation, or other functions. It is contemplated that the bonusing system may be implemented at a remote server 124 in server-based gaming environments. In one embodiment, a bonusing system at a remote server 124 (or at a gaming machine) may be configured to randomly present a bonus triggering indicia in a particular base game being played by a player at one of a plurality of gaming machines to be the winner of the bonusing system's bonus award. Other remote devices, such as a progressive controller or other jackpot controller may be used to implement and provide the bonusing system as well.

It is noted that a gaming machine may comprise a variety of devices configured to provide the features of the bonusing system herein. For example, a gaming machine may be a computer, tablet, smartphone, game console or other portable or desktop computing device that functions as a standalone unit or in cooperation with one or more remote servers 124 to provide the bonusing system herein.

FIG. 2 illustrates components of an exemplary bonusing system 204. As can be seen, the bonusing system may comprise one or more controllers 228 for providing the functionality of the bonusing system 204, such as by receiving player input and sending output signals for controlling the various components of a gaming machine 104 (such as generating game information for presentation by a display device 108). A controller 228 may comprise a microprocessor, chip, electronic circuit, or the like or configured to execute one or more instructions to implement the functions of the bonusing system 204 as detailed herein. In general, the bonusing system 204 randomly allocates bonus awards to particular players, such as by randomly presenting a bonus triggering indicia during a player's base game. Upon receipt of the bonus triggering indicia the player is entitled to its associated bonus award. As stated, the bonus triggering indicia will typically be allocated so as to allow a gaming establishment to provide a large life-changing bonus award. Additional details and embodiments describing operation of the bonusing system 204 are provided below.

In one or more embodiments, the controller 228 may also be configured to provide a base game at the gaming machine 104. For instance, the controller 228 may be arranged to send signals for determining winning combinations and to cause the display 108 to display winning amount information. The controller 228 may also communicate with input devices 112, peripherals, and one or more displays 108 (or other output devices) to allow a player to interact with and play a base game at the gaming machine 104. In addition, the controller 228 may determine if a round of game play has resulted in a win, and if so, the amount to be paid to the player for that win. In this manner only a single controller 228 may be needed in the gaming machine 104.

One or more memory devices 208 may be configured to store data necessary for the operation of the bonusing system 204, one or more base games, or both. It is contemplated that various types of memory devices 208 may be used. For instance, a memory device 208 may utilize various data storage technologies, now known or later developed, including magnetic, optical or flash based storage.

The machine-readable code to implement and/or operate one or more base games, the bonusing system 204 or both may be stored in a memory device 208. Alternatively, it is contemplated that a controller 228 may be hardwired with such instructions. Information related to the play or execution of a base game, the bonusing system 204 or both such as but not limited to credits, amounts wagered, paytables, paylines, odds for a winning outcome, cards/symbols dealt, jackpot amounts, bonuses, the location of a predefined bonus triggering indicia, and randomly generated values may be stored in the memory device 208 as well.

The controller 228 may include or be in communication with one or more random number generators 220 in some embodiments. In general, a random number generator 220 will be used to provide random game outcomes. For example, the random number generator 220 may be used to deal or present random game symbols or indicia to a player for a base game. With regard to the bonusing system 212, a random number generator 220 may be used to allocate bonus awards, as will be described further below.

In some embodiments, one or more communication devices 216 may be provided to allow communication with external devices, such as a remote server 124 as described above. Alternatively or in addition, a communication device 216 may be used to receive bonus information, such as bonus amounts. For example, the bonusing system 204 may be in communication with a progressive bonus system to receive the bonus amount of such system. In this manner, the bonusing system 204 can present and pay out a progressive bonus when a player receives the bonus triggering indicia.

Operation of an exemplary bonusing system will now be described with reference to the flow diagram of FIG. 3. As stated above, the controller of the bonusing system may be configured to control operation of the bonusing system as set forth in the following.

At a step 304, the bonusing system may generate a plurality of sets of indicia for use in play of a base game. The indicia may be different based on the type of base game being played. For example, in a poker, blackjack or other card game, the indicia may be playing card indicia, while in a keno game the indicia may be numbers. The sets of indicia may be generated at different times. For example, in one embodiment, the sets of indicia may be generated when a new base game begins, such as when a player places a wager. In another exemplary embodiment, the sets of indicia may be generated before a base game begins (i.e., generated at the end of one base game for use in the next round or game).

Each set of indicia will comprise a plurality of indicia for use in a base game. Typically, each set of indicia will be a “complete” set to allow play of a base game according to its rules. For example, in a card game, such as poker or blackjack, each set of indicia may be at least one complete deck of playing card indicia. As another example, in a keno game, each set of indicia may be all the numbers required any possible winning combination in the keno game.

At the step 304, the plurality of sets of indicia may be generated by associating a plurality of indicia to each set. Each set of indicia may have the same random order of indicia. This randomization may be accomplished by a shuffling or randomization process, such as shown at a step 308. In some embodiments, this randomization may occur while the plurality of sets of indicia are generated, such as by adding individual indicia to a set of indicia in a random order. It is contemplated that each set of indicia may comprise the same indicia in the same or a different order.

At a step 312, a subset of the plurality of sets of indicia generated at step 304 may be randomly selected. In most embodiments, such subset will consist of only a single set of indicia. A bonus triggering indicia may then be associated or incorporated into the each set of indicia of the subset at a step 316. This allocates the bonus award to the selected each set of indicia within the subset. Typically, a bonus triggering indicia will be inserted at a random position within the selected set of indicia.

It is noted that the subset selected at step 312 may comprise more than one set of indicia in some embodiments. In such case, a bonus triggering indicia would be associated with a plurality of sets of indicia in the selected subset at step 316. The likelihood of winning the bonus award can be increased in this manner.

The bonus triggering indicia will typically be distinguishable from the indicia used in the base game. In this manner, a player can easily determine whether or not he or she has won the bonus award provided by the bonusing system. For example, the bonus triggering indicia may be a distinct color as compared to the indicia of the base game. In a card game, the bonus triggering indicia may be a golden card while the other cards are predominately white (or another non-gold color). The bonus triggering indicia may bear distinct symbols or markings as well as compared to the indicia of the base game. In a keno game for example, the bonus triggering indicia may be a symbol, letter or other non-numeric character.

In one or more embodiments, the bonus triggering indicia will typically not be usable in the base game. It is contemplated that the bonus triggering indicia may be added to an indicia of the base game in other embodiments. For instance, in these embodiments, the bonus triggering indicia may be a symbol or other marking added to a base game indicia. In either case, when presented, the player can readily determine that he or she has won the bonus award provided by the bonusing system.

It is also noted that there may be multiple types of bonus triggering indicia. Various bonus awards may be associated with each type of bonus triggering indicia. For example, each type of bonus triggering indicia may have a bonus award of a different amount associated therewith. A player receiving a bonus triggering indicia may then be paid a bonus award associated with the type of bonus triggering indicia received. It is contemplated that the various types of bonus triggering indicia may be allocated in different ways. For example, bonus triggering indicia that provide higher bonus awards may be included in fewer sets of indicia than bonus triggering indicia that provide lower bonus awards.

At a step 320 one of the plurality of sets of indicia is randomly selected for use in play of the base game presented at the gaming machine. It is noted that this random selection is independent of the random selection steps above. In this manner, the set of indicia selected for use in the base game may or may not include a bonus triggering indicia.

Though described above in a particular sequence, the steps of randomizing the indicia in each set of indicia at step 308, randomly selecting a subset of the sets of indicia at step 312, associating bonus triggering indicia to each selected subset at step 316, and randomly selecting a set of indicia for game play at step 320 may occur in different orders within the spirit and scope of the bonusing system disclosed herein.

Steps 324 to 332 show that the bonusing system may operate in a different mode or manner depending on whether or not the set of indicia selected for use in play of a base game includes a bonus triggering indicia. For instance, at a decision step 324 if the selected set of indicia includes a bonus triggering indicia, the base game may be operated with the bonus award being available for payout at a step 332. As will be described further below, at step 332 if a bonus triggering indicia is received its associated payout will be automatically paid to the player. Alternatively, if the selected set of indicia does not include a bonus triggering indicia, the base game may be operated according to its rules without making the bonus award available at a step 328. At both steps 328 and 332, if the player achieves a winning outcome associated with the base game, he or she wins the award associated with such winning outcome.

It is contemplated that a bonus award funding process may be activated depending on the presence or absence of a bonus triggering indicia in the selected set of indicia, in some embodiments. For example, in one embodiment, a wager or portion thereof made during a base game may be used to fund the bonus award if a bonus triggering indicia is present, while no funding of the bonus award may occur if no bonus triggering indicia is present. In addition or alternatively, one or more award amounts associated with a base game may be reduced if a bonus triggering indicia is present thereby retaining revenue to fund the bonus award. The bonusing system may utilize various other funding processes as well. For example, a portion of all wagers may fund the bonus award regardless of the presence or absence of a bonus triggering indicia. Alternatively or in addition, one or more award amounts associated with a base game may be lowered regardless of the presence or absence of a bonus triggering indicia to retain revenue to fund the bonus award.

Typically, a large number of sets of indicia will be generated at step 304. For example, thousands or millions of individual sets of indicia may be generated at step 304. Since only one set of indicia will typically be selected to have a bonus triggering indicia associated thereto, the likelihood of this particular set of indicia being selected for use in base game play is greatly reduced. This allows a substantial and life-changing bonus award to be provided. Such a bonus award may be in the tens of thousands of dollars for example. In other implementations, a million or multi-million dollar bonus award may be provided. This is highly advantageous in that it allows the bonusing system (and its particular associated base game) to rival popular jackpot games such as Megabucks™, in terms of payout amounts. As stated above, in one or more embodiments, the bonusing system may be linked to other bonusing systems or gaming machines to form a progressive pool to fund its bonus award.

It is contemplated that a particular bonus award may be funded from and awarded via a number of the same or different base games. For example, wagers from various combinations of poker, blackjack and keno games could be used to fund a single progressive bonus award and a player receiving a bonus triggering outcome at any of these games would win the progressive bonus award.

FIG. 4 is a flow diagram illustrating operation of an exemplary base game where the bonus award is available to the player playing the base game. It is noted that the process set forth in the following may be used regardless of whether a bonus triggering indicia is present or absent in the set of indicia selected for use during game play.

At a step 404, a wager on the base game or an aspect thereof may be received from a player. It is noted that a portion of the wager may be allocated to fund the bonus award at step 404, if desired. At a step 408, one or more indicia from the selected set of indicia may be presented to the player. The number of indicia presented at step 408 will be defined by the rules of the base game. For example, in a video poker game five indicia may be dealt to the player, while in a blackjack game two indicia may be dealt to the player.

At a decision step 412, it is determined whether or not a bonus triggering indicia has been received by the player (i.e., dealt or presented to the player). If so, the bonus award is automatically paid to the player at a step 416. If not, one or more wagering and/or indicia presentation rounds may occur according to the rules of the base game. This is shown in FIG. 4 at a decision step 420. To illustrate, if the base game has not ended at decision step 420 (as determined based on the rules of the base game), the process may return to steps 404 and/or 408 where an additional wager and one or more additional indicia may be presented, respectively speaking If any of these additional indicia are bonus triggering indicia, the player would also be paid the bonus award at step 416. As can be seen, regardless of whether the bonus award is paid or not, play of the base game continues according to the rules of the base game after determination of whether a bonus triggering indicia is present or absent at decision step 412.

If the base game has ended at decision step 420, then the outcome of the base game may be evaluated at a decision step 424. If the outcome is a winning outcome of the base game, the player may be paid the award associated with the winning outcome at a step 428. If not, the player's wager(s) are collected by the gaming establishment at a step 432, such as by retaining the wager(s) at the gaming machine.

With respect to a video poker game, an initial set of cards may be dealt to the player at step 408 after receiving the player's wager at step 404. If a bonus triggering indicia is present in the initial cards as determined at decision step 412, the player may be automatically paid the bonus award at step 416. It is contemplated that such bonus triggering indicia may then be replaced with the next base game indicia in the selected set of indicia to allow play of the base game to continue at decision step 420. The game may end pursuant to video poker rules at decision step 420 if the player has a winning outcome in the initial cards that he or she wishes to keep. In such case, determination of the winning outcome is made at decision step 424 and a payout of the associated base game award to the player is made at step 428.

It is contemplated that in some embodiments, the base game may end upon receipt of the bonus triggering indicia. In such case, the player would be paid the bonus award and the base game would end thereafter without evaluating the base game's outcome to determine if a winning outcome has occurred.

At decision step 420, if the player decides to discard one or more cards, as is permitted by typical video poker rules, additional cards may be dealt at step 408. These cards may be evaluated at decision step 412 to determine if a bonus triggering indicia is present with a payout of the bonus award being made at step 416 if a bonus triggering indicia is present. Typically, after this second dealing round, the video poker game will then end at decision step 420. If the outcome of the base game at this point is a winning outcome, as determined at decision step 424, the player may be paid the associated base game award at step 428. If not, the player's wager(s) are collected at step 432, as described above.

With respect to a blackjack game, a wager may be received at step 404 and an initial hand dealt at step 408. If a bonus triggering indicia is present within the initial hand at decision step 412, the bonus award may be automatically paid to the player at step 416. The game may then either end (with the dealer's initial and any additional cards being revealed) at decision step 420 or, if the player decides to “hit”, one or more additional cards may be dealt at step 408. It is noted that an additional wager may be received at step 404, such as if the player decides to split. At the end of the game, if the player's hand beats the dealer's hand, the player may be deemed a winner at decision step 424 and paid a corresponding award at step 428. If not, the player's wager(s) are collected at step 432.

With respect to a keno game, a player's wager may be received at step 404 along with the player's selected keno numbers. At a step 408 keno indicia may be randomly selected and presented by the gaming machine. If, at decision step 412, the keno indicia is a bonus triggering indicia, the player may be automatically paid a bonus award at step 416. At decision step 420, if no winner has been declared, additional keno indicia may be selected and presented at step 408 and this indicia may be evaluated to determine if it is a bonus triggering indicia until the keno game ends. The winning player is paid the award associated with his or her selected keno numbers.

It is contemplated that, in a keno game, the bonus triggering indicia may be a specially marked keno number. In such case, if the player selected the specially marked keno number he or she may be paid the bonus award regardless of whether or not the other keno number selected by the player are presented during the base game. It is contemplated that the bonusing system may operate in this manner for multiplayer keno games.

FIGS. 5A-5B illustrate exemplary bonus triggering indicia 508 as may be presented in a card game, namely, a video poker game. As can be seen from FIG. 5A, the bonus triggering indicia 508 is readily distinguishable from the base game indicia 504. In the case of FIG. 5A, the bonus triggering indicia 508 is a different color (illustrated by its striping) than the base game indicia 504. In addition, the bonus triggering indicia 508 lacks any game play symbols or characters usable during play of the video poker game. In such embodiments, the bonus triggering indicia 508 may be replaced with a base game indicia to continue play of the base game.

In FIG. 5B, the bonus triggering indicia 508 is also readily distinguishable from the base game indicia. However, as can be seen, the bonus triggering indicia 508 is marked with a symbol 512 or other marking to indicate that it is a bonus triggering indicia. In this manner, no replacement of indicia needs to occur for play of the base game to continue.

It is noted that other notifications or alerts may be presented when a bonus triggering indicia 508 is presented. To illustrate, FIGS. 5A-5B show a “BONUS WIN!”

message to notify a player that he or she has won a bonus award provided by the bonusing system. These notifications may include sounds or other audio as well as flashing or other lights. In this manner, the winning of a bonus award is presented with much fanfare to entice other players to play base games associated with the bonusing system in the future.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. A gaming system providing a bonus award comprising:
one or more memory devices for storing one or more individual sets of indicia and a plurality of winning outcomes;
one or more random number generators; and
one or more controllers configured to:
randomize the indicia in the individual sets of indicia;
allocate payout of bonus awards to the one or more individual sets of indicia by selectively associating one or more bonus triggering indicia with the one or more individual sets of indicia, wherein output of the one or more random number generators determines whether any of the one or more bonus triggering indicia are associated with the one or more individual sets of indicia;
receive a wager from a player;
identify a selected one of the individual sets of indicia;
present a plurality of the indicia from the selected individual set of indicia to the player;
award the player a first award if the plurality of indicia include at least one of the one or more bonus triggering indicia; and
award the player an additional second award if the plurality of indicia match at least one of the plurality of winning outcomes;
wherein the first award is presented to the player via a display if awarded.

2. The gaming system of claim 1, wherein the one or more bonus triggering indicia are associated with the one or more individual sets of indicia by adding the bonus triggering indicia at a random location within the one or more individual sets of indicia.

3. The gaming system of claim 1, wherein the one or more bonus triggering indicia are associated with the one or more individual sets of indicia by combining the bonus triggering indicia with a randomly selected indicia within the one or more individual sets of indicia.

4. The gaming system of claim 1, wherein the controller replaces one or more of the plurality of indicia with additional indicia from the selected individual set of indicia before the additional second award is awarded to the player.

5. The gaming system of claim 1, wherein the indicia in the plurality of individual sets of indicia are playing cards.

6. The gaming system of claim 1, wherein each of the plurality of winning outcomes is a predefined poker hand.

7. The gaming system of claim 1, wherein each of the one or more individual sets of indicia consists of the same indicia.

8. A gaming device comprising:
one or more memory devices configured to store one or more individual sets of indicia, wherein the indicia within each of the one or more individual sets of indicia are in a random order;
a controller configured to allocate payout of bonus awards by:
randomly determining whether to associate one or more bonus triggering indicia with at least one of the one or more individual sets of indicia;
associating one or more bonus triggering indicia with at least one of the one or more individual sets of indicia based on the random determination; and
identifying a selected one of the one or more individual sets of indicia; and
a display configured to present a plurality of indicia from the selected individual set of indicia to a player;
wherein the player is awarded a first award only if the plurality of indicia include at least one of the one or more bonus triggering indicia, and the player is awarded an additional second award only if the plurality of indicia form a predefined winning outcome.

9. The gaming device of claim 8, wherein the one or more bonus triggering indicia are associated with the one or more individual sets of indicia by adding the bonus triggering indicia at a random location within the one or more individual sets of indicia.

10. The gaming device of claim 8, wherein the one or more bonus triggering indicia are associated with the one or more individual sets of indicia by combining the bonus triggering indicia with a randomly selected indicia within the one or more individual sets of indicia.

11. The gaming device of claim 8, wherein the controller replaces one or more of the plurality of indicia with additional indicia from the selected individual set of indicia before the additional second award is awarded to the player.

12. The gaming device of claim 8, wherein the indicia in the plurality of individual sets of indicia are playing cards.

13. The gaming device of claim 8, wherein each of the predefined winning outcome is a predefined poker hand.

14. The gaming device of claim 8, wherein each of the one or more individual sets of indicia consists of the same indicia.

15. The gaming device of claim 8 further comprising a wager acceptor, wherein a wager must be received via the wager acceptor before the plurality of indicia are presented on the display.

16. A method for allocating bonus awards with a gaming system comprising:
storing one or more individual sets of indicia on one or more memory devices, wherein the indicia within each of the one or more individual sets of indicia are in a random order;
allocating payout of bonus awards by randomly associating one or more bonus triggering indicia with the one or more individual sets of indicia based on output of one or more random number generators;
randomly selecting one of the plurality of sets of indicia for use in play of a base game;
receiving a wager from a player via an input device;
providing one or more game rounds during the base game during which a plurality of indicia from the randomly selected set of indicia are presented to the player via a display;
awarding the player a first award if the plurality of indicia includes at least one of the one or more bonus triggering indicia; and
awarding the player a second additional award if the plurality of indicia forms a predefined winning outcome.

17. The gaming device of claim 16, wherein the one or more bonus triggering indicia are associated with the one or more individual sets of indicia by adding the bonus triggering indicia at a random location within the one or more individual sets of indicia.

18. The gaming device of claim 16, wherein the one or more bonus triggering indicia are associated with the one or more individual sets of indicia by combining the bonus triggering indicia with a randomly selected indicia within the one or more individual sets of indicia.

19. The method of claim 16, wherein the indicia in the plurality of sets of indicia are playing cards.

20. The method of claim 16, wherein each of the individual sets of indicia consists of the same indicia.
